(19) United States
(12) Patent Application Publication
(10) Pub. No.: US 2025/0316711 A1
(43) Pub. Date: Oct. 9, 2025

(54) COMPOSITE CURRENT COLLECTOR AND MANUFACTURING METHOD THEREFOR, COMPOSITE ELECTRODE SHEET AND MANUFACTURING METHOD THEREFOR, AND LITHIUM BATTERY

(71) Applicant: ADVANCED MATERIALS TECHNOLOGY (BEIJING) CO., LTD., Beijing (CN)

(72) Inventors: Xinsen SUN, Beijing (CN); Yongwei LI, Beijing (CN); Xiaobing YANG, Beijing (CN); Yiwei FENG, Beijing (CN); Xiufeng GONG, Beijing (CN); Weichao FAN, Beijing (CN); Dongliang LI, Beijing (CN); Hongfeng JIANG, Beijing (CN); Yanru JIANG, Beijing (CN); Gang LIU, Beijing (CN)

(73) Assignee: ADVANCED MATERIALS TECHNOLOGY (BEIJING) CO., LTD., Beijing (CN)

(21) Appl. No.: 19/246,494

(22) Filed: Jun. 23, 2025

Related U.S. Application Data
(63) Continuation of application No. PCT/CN2023/140397, filed on Dec. 20, 2023.

(30) Foreign Application Priority Data
Dec. 23, 2022 (CN) 202211665068.2
Dec. 23, 2022 (CN) 202211667775.5

(51) Int. Cl. H01M 4/66; H01M 4/02; H01M 4/04; H01M 4/505; H01M 4/525; H01M 4/58; H01M 4/587

(52) U.S. Cl. CPC H01M 4/667; H01M 4/0404; H01M 4/0426; H01M 4/505; H01M 4/525; H01M 4/5825; H01M 4/587; H01M 4/661; H01M 4/668; H01M 2004/021; H01M 2004/027; H01M 2004/028

(57) ABSTRACT

A composite current collector and a manufacturing method therefor, a composite electrode sheet and a manufacturing method therefor, and a lithium battery are provided. The composite current collector includes: a substrate layer; a first metal material layer, which is arranged on one side of the substrate layer, and is to be coated with a first active material on the side away from the substrate layer; and a second metal material layer, which is arranged on the side of the substrate layer away from the first metal material layer, and is to be coated with a second active material on the side away from the substrate layer, with the polarity of the second active material being opposite to the polarity of the first active material.

### CROSS-REFERENCE TO RELATED APPLICATIONS

The present application is based on the Chinese application with the CN application number of 202211667775.5 filed on Dec. 23, 2022 and the Chinese application with the CN application No. 202211665068.2 filed on Dec. 23, 2022, and claims its priority. The disclosure content of these CN applications is introduced into the present application as a whole.

### TECHNICAL FIELD

The present disclosure relates to the field of lithium battery technology, and specifically, to a composite current collector and a manufacturing method therefor, a composite electrode sheet and a manufacturing method therefor, and a lithium battery.

### BACKGROUND

Lithium-ion batteries, referred to as lithium batteries, are widely used in daily life as efficient energy storage devices. A traditional lithium-ion battery cell contains cathode and anode sheets in pair, which are stacked in multiple layers or wound to obtain battery cells of different capacities. In traditional lithium-ion batteries, the volume of the active material part that effectively stores energy is small, while the volume of the cathode current collector in the cathode sheet and the anode current collector in the anode sheet are large, resulting in a low effective energy-to-volume ratio of lithium-ion batteries.

A bipolar current collector refers to a composite material having a cathode metal layer deposited on one surface of a polymer film and an anode metal layer deposited on the other surface. At present, the cathode metal layer of the bipolar current collector is generally made of aluminum, and the anode metal layer is generally made of copper. However, such bipolar current collectors generally have defects such as low volume energy density, poor ductility, and high surface density.

### SUMMARY

A first purpose of the present disclosure is to provide a composite current collector and a manufacturing method therefor, a composite electrode sheet and a manufacturing method therefor, and a lithium battery, which can be used to solve the technical problem of low effective energy-to-volume ratio of lithium batteries at present.

In embodiments of the present disclosure, a composite current collector for lithium batteries is provided, including a substrate layer, a first metal material layer, and a second metal material layer. Specifically, the first metal material layer is arranged on one side of the substrate layer, and is to be coated with a first active material on the side away from the substrate layer; and the second metal material layer is arranged on the side of the substrate layer away from the first metal material layer, and is to be coated with a second active material on the side away from the substrate layer, with the polarity of the second active material being opposite to the polarity of the first active material.

In some embodiments, the first metal material layer includes a first metal material sublayer and a second metal material sublayer. Specifically, the first metal material sublayer is arranged on one side of the substrate layer; and the second metal material sublayer is arranged on the side of the first metal material sublayer away from the substrate layer, and is to be coated with a first active material on the side away from the first metal material sublayer.

In some embodiments, the orthographic projection of the first metal material sublayer on the substrate layer coincides with the orthographic projection of the second metal material sublayer on the substrate layer.

In some embodiments, the material of the substrate layer includes one or more constituents selected from the group consisting of polyethylene terephthalate, o-phenylphenol, cast polypropylene, polyimide, polyvinyl chloride, polybutylene terephthalate, polyethylene naphthalate, polyetheretherketone, polyamide, polyethylene glycol, polyamide-imide, polycarbonate, cyclic olefin polymer/copolymer, polyphenylene sulfide, polyvinyl acetate, polytetrafluoroethylene, polymethylenenaphthalene, polyvinylidene fluoride, polypropylene carbonate, poly(vinylidene fluoride-co-hexafluoropropylene), poly(vinylidene fluoride-co-chlorotrifluoroethylene), silicone, vinylon, polypropylene, polyethylene, polystyrene, polyethernitrile, polyurethane, polyphenylene ether, polyester, polysulfone, and their derivatives.

In some embodiments, the thickness of the substrate layer is 4-8 μm.

In some embodiments, the material of any one of the first metal material layer and the second metal material layer includes one or more elements selected from the group consisting of Ni, Ti, Cu, Ag, Au, Pt, Fe, Co, Cr, W, Mo, Al, Mg, K, Na, Ca, Sr, Ba, Si, Ge, Sb, Pb, In, and Zn.

In some embodiments, the material of the first metal material sublayer includes Al, and the material of the second metal material sublayer includes Cu.

In some embodiments, the thickness of the first metal material sublayer is 0.2-2 μm, and the thickness of the second metal material sublayer is 0.1-2 μm.

In some embodiments, the material of the second metal material layer includes Al, and the thickness of the second metal material layer is 0.3-4 μm.

In some embodiments, at least one of the first metal material sublayer and the second metal material sublayer is formed by using one or more methods selected from the group consisting of evaporation, deposition, and sputtering.

In some embodiments, the second metal material layer is formed by using one or more methods selected from the group consisting of evaporation, deposition, and sputtering.

In some embodiments, the first active material includes an anode active material, and the second active material includes a cathode active material.

In some embodiments of the present disclosure, a composite electrode sheet is provided, including the composite current collector, the first active material layer, and the second active material layer in the embodiments described above. Specifically, the first active material layer is arranged on the side of the first metal material layer away from the substrate layer, and the second active material layer is arranged on the side of the second metal material layer away from the substrate layer.

In some embodiments of the present disclosure, a lithium battery is provided, including the composite electrode sheet in the embodiments described above.

In some embodiments of the present disclosure, a method for manufacturing the composite current collector is provided, including: providing a substrate layer; forming a first metal material layer on the substrate layer, specifically, the first metal material layer is to be coated with a first active material on the side away from the substrate layer; and forming a second metal material layer on the side of the substrate layer away from the first metal material layer, specifically, the second metal material layer is to be coated with a second active material on the side away from the substrate layer, with the polarity of the second active material is opposite to the polarity of the first active material.

In some embodiments, the forming a first metal material layer on the substrate layer includes forming a first metal material sublayer on one side of the substrate layer, and forming a second metal material sublayer on the side of the first metal material sublayer away from the substrate layer. Specifically, the second metal material sublayer is to be coated with a first active material on the side away from the first metal material sublayer.

In some embodiments, the orthographic projection of the first metal material sublayer on the substrate layer coincides with the orthographic projection of the second metal material sublayer on the substrate layer.

In some embodiments, the forming a first metal material sublayer on one side of the substrate layer includes forming an Al-made first metal material sublayer on one side of the substrate layer by using one or more methods selected from the group consisting of evaporation, deposition, and sputtering.

In some embodiments, the forming a second metal material sublayer on the side of the first metal material sublayer away from the substrate layer includes forming a Cu-made second metal material sublayer on the side of the first metal material sublayer away from the substrate layer by using one or more methods selected from the group consisting of evaporation, deposition, and sputtering.

In some embodiments, the forming a second metal material layer on the side of the substrate layer away from the first metal material layer includes: forming an Al-made second metal material layer on the side of the substrate layer away from the first metal material layer by using one or more methods selected from the group consisting of evaporation, deposition, and sputtering.

In some embodiments of the present disclosure, a method for manufacturing the composite electrode sheet is provided, including: the method for manufacturing the composite current collector in the embodiments described above; coating a first active material on one side of the first metal material layer away from the substrate layer; and coating a second active material on one side of the second metal material layer away from the substrate layer.

Compared with the related art, embodiments of the present disclosure have the following technical effects: The composite current collector according to the present disclosure can be coated with a cathode active material and an anode active material on the two sides respectively, to form a composite electrode sheet. The composite current collector of the composite electrode sheet can be very thin compared to the cathode current collector of the cathode sheet and the anode current collector of the anode sheet of conventional lithium batteries, and can be used to improve the effective energy-to-volume ratio of lithium batteries.

A second purpose of the present disclosure is to solve the problems of existing bipolar current collectors, such as low volume energy density, poor ductility and high surface density, and to provide a bipolar current collector and a preparation method therefor, as well as a bipolar electrode and a lithium battery.

For the second purpose described above, in a first aspect, the present disclosure provides a bipolar current collector includes a cathode metal layer, an anode metal layer, and a substrate disposed between the cathode metal layer and the anode metal layer, among which the material of the cathode metal layer includes one or more elements selected from the group consisting of Ni, Ti, Ag, Au, Pt, Co, Cr, W, Mo, Al, Mg, Ba, Ge, Sb, In, and Zn, and the material of the anode metal layer includes one or more elements selected from the group consisting of Ni, Ti, Cu, Ag, Au, Pt, Co, Cr, W, Mo, Mg, Ba, Si, Ge, Sb, In, and Zn. The bipolar current collector is a composite current collector.

In a second aspect, the present disclosure provides a method for preparing the bipolar current collector according to the first aspect of the present disclosure, including: depositing the cathode metal layer and the anode metal layer on the two surfaces of the substrate respectively. Specifically, the depositing is carried out by using one or more methods selected from the group consisting of evaporation, sputtering, chemical vapor deposition, and chemical plating.

In a third aspect, the present disclosure provides a bipolar electrode, including a cathode active substance, an anode active substance, and the bipolar current collector according to the first aspect of the present disclosure, among which the cathode active substance is arranged on the cathode metal layer of the bipolar current collector, and the anode active substance is arranged on the anode metal layer of the bipolar current collector.

In a fourth aspect, the present disclosure provides a lithium battery including the bipolar electrode according to the third aspect of the present disclosure.

The bipolar current collector according to the present disclosure has high conductivity, good ductility and low surface density, and can significantly improve the effective volume energy density of lithium batteries. The method for preparing the bipolar current collector according to the present disclosure is featured by a simple preparation process, high preparation efficiency, and low processing difficulty, and is suitable for industrial promotion.

### BRIEF DESCRIPTION OF DRAWINGS

The drawings herein are incorporated into and form a part of the specification, showing embodiments of the present disclosure, and are used together with the specification to explain the principle of the present disclosure. Obviously, the drawings described below are only some embodiments of the present disclosure, and those skilled in the art can derive other drawings from these drawings without creative efforts. Among the figures:

FIG. 1 is a schematic diagram of the structure of a composite current collector according to some embodiments of the present disclosure;

FIG. 2 is a schematic diagram of the structure of a composite electrode sheet according to some embodiments of the present disclosure;

FIG. 3 is a flow chat of a method for manufacturing the composite current collector according to some embodiments of the present disclosure;

FIG. 4 is a specific flow chart of step S20 in FIG. 3;

FIG. 5 is a flow chart of a method for manufacturing the composite electrode sheet according to some embodiments of the present disclosure; and

FIG. 6 is a schematic diagram of the structure of a bipolar current collector according to a preferred embodiment of the present disclosure.

### REFERENCE NUMERALS

100. composite current collector; 10. first metal material layer; 11. first metal material sublayer; 20. second metal material layer; 30. substrate layer; 1000. composite electrode sheet; 41. first active material layer; 42. second active material layer; 1. cathode metal layer; 2. anode metal layer; 3. substrate.

### DETAILED DESCRIPTION OF THE EMBODIMENTS

In order to make the objectives, technical solutions, and advantages of the present disclosure clearer, the present disclosure will be further described in detail below with reference to the drawings. Obviously, the embodiments described are only some, not all, of the embodiments of the present disclosure. Based on the embodiments described herein, all other embodiments obtained by those of ordinary skill in the art without creative efforts shall fall within the protection scope of the present disclosure.

The terminology used in the disclosed embodiments is for purposes of describing particular embodiments only and not intended to limit the present disclosure. The singular forms of “a”, “the” and “this” as used in embodiments of the present disclosure and the appended claims are also intended to include the plurality of forms, unless the context clearly indicates other meanings, “multiple” generally includes at least two.

It should be understood that the term “and/or” as used in this document is only an association relationship describing associated objects, indicating that three relationships can exist, e.g., A and/or B, which may indicate that there are three cases: A alone, both A and B, and B alone. In addition, the character “/” in this document generally indicates that the context-related object is an “or” relationship.

It should be understood that although the terms first, second, third and so on may be used to describe in embodiments of the present disclosure, these should not be limited to these terms. These terms are used only to differentiate. For example, the first may also be referred to as a second without departing from the scope of embodiments of the present disclosure, and similarly, the second may also be referred to as a first.

It should also be clarified that the terms “comprising”, “comprises” or any other variation thereof are intended to cover non-exclusive inclusion, so that a commodity or installation comprising a list of elements includes not only those elements but also other elements not expressly listed therein, or elements inherent in such commodity or installation. Without further limitation, an element qualified by the phrase “comprising a” does not preclude the presence of additional identical elements in the commodity or installation that include such an element.

In the related art, a lithium battery usually includes cathode and anode sheets, which are stacked in multiple layers or wound to obtain battery cells of different capacities. The cathode sheet usually includes a cathode current collector and a cathode active substance coated on both sides of the cathode current collector. The cathode current collector is usually made of aluminum foil, which is generally 10-15 microns thick. The anode sheet usually includes an anode current collector and an anode active material coated on both sides of the anode current collector. The anode current collector is usually made of copper foil, which is generally 4.5-9 microns thick. The cathode active material is coated on both sides of the aluminum foil, and is made into the cathode sheet by baking, rolling, slitting and die-cutting. The anode active material is coated on both sides of the copper foil, and is made into the anode sheet by baking, rolling, slitting and die-cutting. Then the anode sheet, the separator and the cathode sheet are stacked or wound in sequence to make the lithium battery cell. In the lithium battery cell, the cathode active substance and the anode active substance serve to store the energy. The cathode current collector and the anode current collector only serve as the conductors, and have no effect on energy storage. Since the cathode current collector and the anode current collector occupy a considerable volume, the effective energy-to-volume ratio of lithium batteries is low, which is not conducive to the miniaturization of lithium batteries.

In embodiments of the present disclosure, a composite current collector for lithium batteries is provided, including: a substrate layer; a first metal material layer, which is arranged on one side of the substrate layer, and is to be coated with a first active material on the side away from the substrate layer; and a second metal material layer, which is arranged on the side of the substrate layer away from the first metal material layer, and is to be coated with a second active material on the side away from the substrate layer is, with the polarity of the second active material is opposite to the polarity of the first active material.

The composite current collector according to the present disclosure can be coated with a cathode active material and an anode active material on the two sides respectively, to form a composite electrode sheet. The composite current collector of the composite electrode sheet can be very thin compared to the cathode current collector of the cathode sheet and the anode current collector of the anode sheet, and can be used to improve the effective energy-to-volume ratio of lithium batteries.

Optional embodiments of the present disclosure are described in detail below with reference to the drawings.

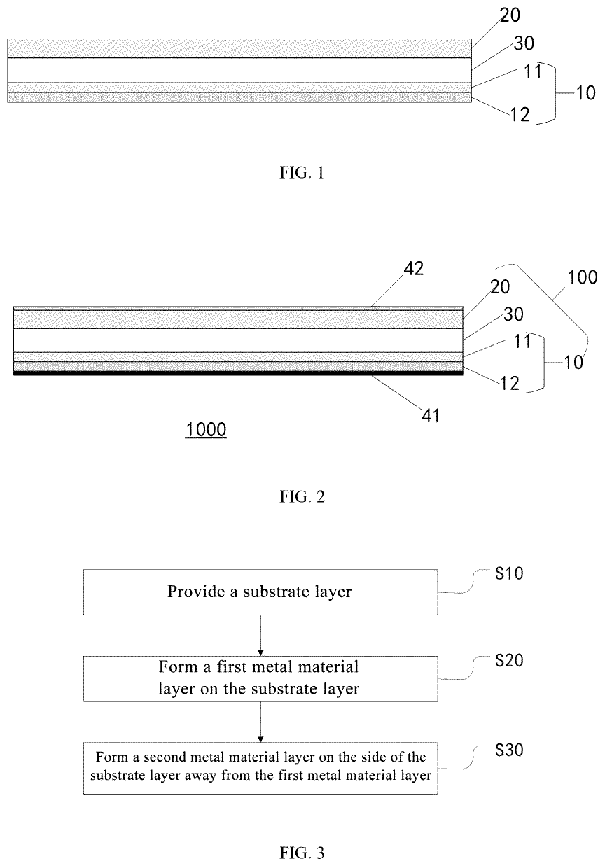

FIG. 1 is a schematic diagram of the structure of a composite current collector according to some embodiments of the present disclosure. As shown in FIG. 1, in embodiments of the present disclosure, a composite current collector 100 for lithium batteries is provided, and specifically, the composite current collector 100 includes a substrate layer 30, a first metal material layer 10, and a second metal material layer 20.

Specifically, the substrate layer, such as a high molecular polymer substrate layer, has good insulation properties, and can be very thin. The first metal material layer 10 is arranged on one side, such as the lower side shown in FIG. 1, of the substrate layer 30, and the first metal material layer 10 is to be coated with a first active material on the side away from the substrate layer 30. The second metal material layer 20 is arranged on the side of the substrate layer 30 away from the first metal material layer 10, and the second metal material layer 20 is to be coated with a second active material on the side away from the substrate layer 30, with the polarity of the second active material being opposite to the polarity of the first active material. The first active material is, for example, one selected from the pair of a cathode active material and an anode active material, and the second active material is, for example, the other selected from the pair of a cathode active material and an anode active material.

For the composite current collector according to embodiments of the present disclosure, the polymer substrate layer can be coated with a first metal material layer and a second metal material layer on the two sides respectively by a film forming process, and the composite current collector formed in this way can be very thin. The composite current collector can be coated with a cathode active substance and an anode active substance on the two sides respectively to form a composite electrode sheet, and the composite electrode sheet formed in this way can be very thin, to increases the volume proportions of the cathode active substance and the anode active substances used for energy storage, which is conducive to improving the effective energy-to-volume ratio of lithium batteries.

In some embodiments, as shown in FIG. 1, the first metal material layer 10 includes a first metal material sublayer 11 and a second metal material sublayer 12, which are arranged in a stacked manner. The first metal material sublayer 11 is arranged on one side, such as the lower side shown in FIG. 1, of the substrate layer 30. The second metal material sublayer 12 is arranged on the side of the first metal material sublayer 11 away from the substrate layer 30, and the second metal material sublayer 12 is to be coated with the first active material on the side away from the first metal material sublayer 11.

As described above, the first metal material layer 10 can be a multi-layer metal film layer that is composed of, for example, 2 or more layers. In some embodiments, the first metal material sublayer 11 is made of, for example, Al, and the second metal material sublayer 12 is made of, for example, Cu. The Cu-made second metal material sublayer 12 is usually used to coat the first active material, such as an anode active material. Since the cost of Cu is high, directly forming the Cu-made second metal material sublayer 12 on the substrate layer 30 to the predetermined film thickness will result in high cost. The Al-made first metal material sublayer 11 with a lower cost can be formed on the substrate layer 30, and then the Cu-made second metal material sublayer 12 with a smaller thickness can be formed on the side of the Al-made first metal material sublayer 11 away from the substrate layer 30, to cut down the manufacturing cost. The second metal material sublayer 12 for carrying the first active material may not be easy to form a film on the substrate layer 30 that is made of some specific materials. In such cases, the first metal material sublayer 11 that is easy to form a film can be formed on the substrate layer 30 first, and then the second metal material sublayer 12 can be formed on the side of the first metal material sublayer 11 away from the substrate layer 30, to ensure the structural stability of the composite current collector.

In some embodiments, as shown in FIG. 1, the orthographic projection of the first metal material sublayer 11 on the substrate layer 30 coincides with the orthographic projection of the second metal material sublayer 12 on the substrate layer 30. The second metal material sublayer 12 substantially completely covers the first metal material sublayer 11. The side of the second metal material sublayer 12 away from the first metal material sublayer 11 is used to coat the first active material.

In some embodiments, the material of the substrate layer 30 can be a high molecular polymer material with insulating properties, and can form a film layer with a stable structure and a small thickness. The material of the substrate layer 30 can include, for example, one or more constituents selected from the group consisting of polyethylene terephthalate, o-phenylphenol, cast polypropylene, polyimide, polyvinyl chloride, polybutylene terephthalate, polyethylene naphthalate, polyetheretherketone, polyamide, polyethylene glycol, polyamide-imide, polycarbonate, cyclic olefin polymer/copolymer, polyphenylene sulfide, polyvinyl acetate, polytetrafluoroethylene, polymethylenenaphthalene, polyvinylidene fluoride, polypropylene carbonate, poly(vinylidene fluoride-co-hexafluoropropylene), poly(vinylidene fluoride-co-chlorotrifluoroethylene), silicone, vinylon, polypropylene, polyethylene, polystyrene, polyethernitrile, polyurethane, polyphenylene ether, polyester, polysulfone, and their derivatives.

In some embodiments, the substrate layer 30 can include polyethylene terephthalate (PET) or o-phenylphenol (OPP), which can result in better insulation properties and structural stability, and low manufacturing cost.

In some embodiments, the thickness of the substrate layer 30 is 4-8 μm, for example, 5-7 μm. The substrate layer 30 needs to be as thin as possible while ensuring its insulation properties and structural stability, to improve the effective energy-to-volume ratio of lithium-ion batteries.

In some embodiments, the material of any one of the first metal material layer and the second metal material layer includes one or more elements selected from the group consisting of Ni, Ti, Cu, Ag, Au, Pt, Fe, Co, Cr, W, Mo, Al, Mg, K, Na, Ca, Sr, Ba, Si, Ge, Sb, Pb, In, and Zn. The first metal material layer and the second metal material layer are coated with a first active material and a second active material respectively, both of which need to have good conductivity to facilitate smooth flow of charges thereon.

In some embodiments, as shown in FIG. 1, the material of the first metal material sublayer 11 includes Al, and the material of the second metal material sublayer 12 includes Cu. The second metal material sublayer 12 is coated with a first active material, such as an anode active material, on the surface away from the first metal material sublayer 11.

Cu resources are abundant and relatively cheap, and a Cu film layer has a certain ductility, which is conducive to winding the composite current collector in the process of manufacturing lithium batteries. Cu itself is relatively stable in air and basically does not react in dry air, but its oxidation potential is low and it is easily oxidized at high potentials. Therefore, Cu is more suitable for coating anode active materials than cathode active materials. In some embodiments, the first metal material layer 10 can be formed into a Cu single film layer.

Al resources are more abundant and cheaper than Cu. Al further has good conductivity and can be closely stacked with the Cu film. In some embodiments of the present disclosure, as shown in FIG. 1, the first metal material layer 10 is a double-layer structure to ensure the conductive effect while further cutting down the cost.

In some embodiments, as shown in FIG. 1, the thickness of the first metal material sublayer 11 is 0.2-2 μm, for example, 1 μm. The thickness of the second metal material sublayer is 0.1-2 μm, for example, 1 μm. The overall thickness of the first metal material layer 10 needs to be as thin as possible, while ensuring its conductive properties, ductility, and structural stability, to improve the effective energy-to-volume ratio of lithium-ion batteries.

In some embodiments, as shown in FIG. 1, the material of the second metal material layer includes Al, and the thickness of the second metal material layer is 0.3-4 μm, for example, 2 μm. As described above, Al resources are abundant and very cheap, and an Al film layer has a certain ductility, which is conducive to winding the composite current collector in the process of manufacturing lithium batteries. Al itself is relatively stable in air and basically does not react in dry air. It has a high oxidation potential and is not easily oxidized at high potentials, so Al is suitable for coating cathode active substances. The second metal material layer 20 can be formed into an Al single film layer. The overall thickness of the second metal material layer 20 needs to be as thin as possible, while ensuring its conductive properties, ductility, and structural stability, to improve the effective energy-to-volume ratio of lithium-ion batteries.

In some embodiments, as shown in FIG. 1, at least one of the first metal material sublayer 11 and the second metal material sublayer 12 is formed by using one or more methods selected from the group consisting of evaporation, deposition, and sputtering. The second metal material layer 20 is formed by using one or more methods selected from the group consisting of evaporation, deposition, and sputtering.

Specifically, evaporation may include vacuum evaporation and ion plating; deposition may include chemical vapor deposition, plasma vapor deposition, atomic layer deposition, and pulsed laser deposition; and sputtering may include radio frequency sputtering, magnetron sputtering, and reactive sputtering.

According to test results, the sheet resistance of the first metal material layer 10 is 33 mΩ/sq, indicating that the first metal material layer 10 composed of the first metal material sublayer 11 and the second metal material sublayer 12 has good conductivity.

In some embodiments, the first active material includes an anode active material, and the second active material includes a cathode active material. Cathode active materials include, for example, lithium-containing transition metal oxides and phosphides such as LiCoO₂ and LiFePO₄; and anode active materials include, for example, carbon materials such as artificial graphite, natural graphite, mesocarbon microbeads, petroleum coke, carbon fiber, and pyrolytic carbon from resins.

FIG. 2 is a schematic diagram of the structure of a composite electrode sheet according to some embodiments of the present disclosure. As shown in FIG. 2, in some embodiments of the present disclosure, a composite electrode sheet 1000 is provided. Specifically, the composite electrode sheet 1000 includes the composite current collector 100, the first active material layer 41, and the second active material layer 42 in the embodiments described above.

The specific structure of the composite current collector 100 has been described in detail in the embodiments described above and will not be repeated here.

The first active material layer 41 is arranged on the side of the first metal material layer 10 away from the substrate layer 30, and is formed, for example, by coating an anode active material slurry on the side of the first metal material layer 10 away from the substrate layer 30. Specifically, the anode active material slurry is formed, for example, on the side of the second metal material sublayer 12 away from the first metal material sublayer 11 by a coating process. Coating processes include, for example, spraying, press printing, printing, roller coating, and spin coating.

The second active material layer 42 is arranged on the side of the second metal material layer 20 away from the substrate layer 30. It is formed, for example, by coating a cathode active material slurry on the side of the first metal material layer 20 away from the substrate layer 30.

In the composite electrode sheet according to the present disclosure, the composite current collector can be very thin compared with the cathode current collector of the cathode sheet and the anode current collector of the anode sheet of a conventional lithium battery, and can be used to improve the effective energy-to-volume ratio of lithium batteries.

The present disclosure further provides a lithium battery, including the composite electrode sheet according to the embodiments described above. Specifically, the composite electrode sheet can form the lithium battery cell by conventional stacking or winding, and then the lithium battery cell is covered by the protective shell to form the lithium battery. Since the composite current collector can be very thin compared with the cathode current collector of the cathode sheet and the anode current collector of the anode sheet of a conventional lithium battery, the lithium battery according to the present disclosure can have a better effective energy-to-volume ratio.

In some embodiments of the present disclosure, a method for manufacturing the composite current collector is further provided. FIG. 3 shows a method for manufacturing the composite current collector according to some embodiments of the present disclosure. As shown in FIG. 3, the method for manufacturing a composite current collector includes the following steps:

S10: Provide a substrate layer.

Specifically, the material of the substrate layer can be a high molecular polymer material with insulating properties, and can form a film layer with a stable structure and a small thickness. The material of the substrate layer can include, for example, one or more constituents selected from the group consisting of polyethylene terephthalate, o-phenylphenol, cast polypropylene, polyimide, polyvinyl chloride, polybutylene terephthalate, polyethylene naphthalate, polyetheretherketone, polyamide, polyethylene glycol, polyamide-imide, polycarbonate, cyclic olefin polymer/copolymer, polyphenylene sulfide, polyvinyl acetate, polytetrafluoroethylene, polymethylenenaphthalene, polyvinylidene fluoride, polypropylene carbonate, poly(vinylidene fluoride-co-hexafluoropropylene), poly(vinylidene fluoride-co-chlorotrifluoroethylene), silicone, vinylon, polypropylene, polyethylene, polystyrene, polyethernitrile, polyurethane, polyphenylene ether, polyester, polysulfone, and their derivatives. The substrate layer can be outsourced or produced in-house.

S20: Form a first metal material layer on the substrate layer. Specifically, the first metal material layer is to be coated with a first active material on the side away from the substrate layer.

The material of the first metal material layer includes one or more elements selected from the group consisting of Ni, Ti, Cu, Ag, Au, Pt, Fe, Co, Cr, W, Mo, Al, Mg, K, Na, Ca, Sr, Ba, Si, Ge, Sb, Pb, In, and Zn. Specifically, in some embodiments, the first metal material layer can be formed as a Cu single film layer. Cu resources are abundant and relatively cheap, and a Cu film layer has a certain ductility, which is conducive to winding the composite current collector in the process of manufacturing lithium batteries. Cu itself is relatively stable in air and basically does not react in dry air, but its oxidation potential is low and it is easily oxidized at high potentials. Therefore, Cu is more suitable for coating anode active materials than cathode active materials.

S30: Form a second metal material layer on the side of the substrate layer away from the first metal material layer. Specifically, the second metal material layer is to be coated with a second active material on the side away from the substrate layer, with the polarity of the second active material being opposite to that of the first active material.

The material of the second metal material layer includes one or more elements selected from the group consisting of Ni, Ti, Cu, Ag, Au, Pt, Fe, Co, Cr, W, Mo, Al, Mg, K, Na, Ca, Sr, Ba, Si, Ge, Sb, Pb, In, and Zn. Specifically, in some embodiments, the second metal material layer can be formed as an Al single film layer. Al resources are abundant and very cheap, and an Al film layer has a certain ductility, which is conducive to winding the composite current collector in the process of manufacturing lithium batteries. Al itself is relatively stable in air and basically does not react in dry air. It has a high oxidation potential and is not easily oxidized at high potentials, so Al is suitable for coating cathode active substances.

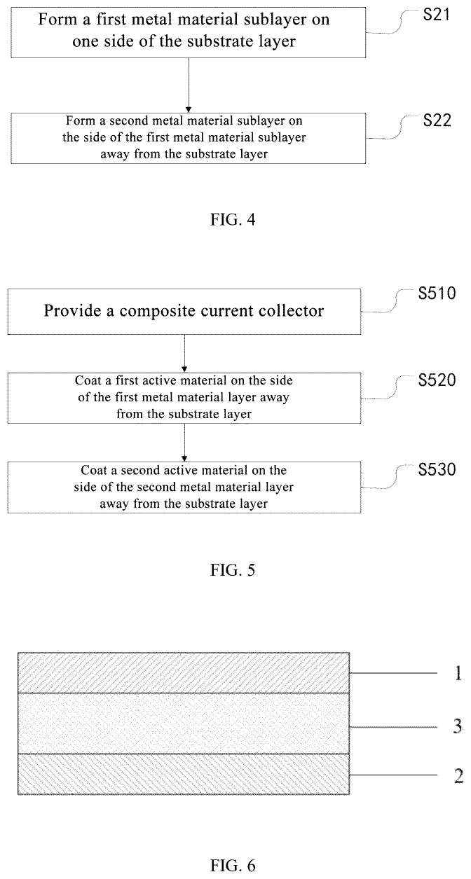

FIG. 4 is a specific flow chart of step S20 in FIG. 3. In some embodiments, step S20 includes the following specific steps:

S21: Form a first metal material sublayer on one side of the substrate layer.

Specifically, in some embodiments, the material of the first metal material sublayer includes Al, and the thickness of the first metal material sublayer is 0.2-2 μm, for example, 1 μm.

S22: Form a second metal material sublayer on the side of the first metal material sublayer away from the substrate layer. Specifically, the second metal material sublayer is to be coated with the first active material on the side away from the first metal material sublayer.

Specifically, in some embodiments, the material of the second metal material sublayer includes Cu, and the thickness of the second metal material sublayer is 0.1-2 μm, for example, 1 μm.

Since Al resources are more abundant and cheaper than Cu, and Al further has good conductivity and can be closely stacked with the Cu film, a double-layer film formed by stacking the Al layer and the Cu layer can be used instead of a Cu single film layer, to further cut down the cost.

The overall thickness of the first metal material layer needs to be as thin as possible, while ensuring its conductive properties, ductility, and structural stability, to improve the effective energy-to-volume ratio of lithium-ion batteries.

In some embodiments, the orthographic projection of the first metal material sublayer on the substrate layer coincides with the orthographic projection of the second metal material sublayer on the substrate layer. The second metal material sublayer substantially completely covers the first metal material sublayer. The side of the second metal material sublayer away from the first metal material sublayer is used to coat the first active material.

In some embodiments, in step S21, an Al-made first metal material sublayer is formed on one side of the substrate layer by using one or more methods selected from the group consisting of evaporation, deposition, and sputtering.

In some embodiments, in step S22, a Cu-made second metal material sublayer is formed on the side of the first metal material sublayer away from the substrate layer by using one or more methods selected from the group consisting of evaporation, deposition, and sputtering.

In some embodiments, in step S30, an Al-made second metal material layer is formed on the side of the substrate layer away from the first metal material layer by using one or more methods selected from the group consisting of evaporation, deposition, and sputtering.

Specifically, evaporation may include vacuum evaporation and ion plating; deposition may include chemical vapor deposition, plasma vapor deposition, atomic layer deposition, and pulsed laser deposition; and sputtering may include radio frequency sputtering, magnetron sputtering, and reactive sputtering.

In some embodiments of the present disclosure, a method for manufacturing the composite electrode sheet is further provided. FIG. 5 shows a flow chart of the method for manufacturing the composite electrode sheet according to some embodiments of the present disclosure. The method for manufacturing the composite electrode sheet specifically includes the following steps:

S510: Provide a composite current collector.

Specifically, the composite current collector can be manufactured by the method according to the embodiments described above, which will not be repeated here.

S520: Coat a first active material on the side of the first metal material layer away from the substrate layer.

Specifically, the first active material slurry, such as an anode active material slurry, is coated on the side of the first metal material layer away from the substrate layer, to form the first active material layer, such as an anode active material layer. Coating processes include, for example, spraying, press printing, printing, roller coating, and spin coating.

S530: Coat a second active material on the side of the second metal material layer away from the substrate layer.

Specifically, the second active material slurry, such as a cathode active material slurry, is coated on the side of the second metal material layer away from the substrate layer, to form the second active material layer, such as a cathode active material layer. Coating processes include, for example, spraying, press printing, printing, roller coating, and spin coating.

According to test results, the sheet resistance of the first metal material layer 10 is 33 mΩ/sq, indicating that the first metal material layer 10 composed of the first metal material sublayer 11 and the second metal material sublayer 12 has good conductivity.

The direct tensile force of the composite current collector 100 is 27 N/15 mm, greater than that of traditional current collectors, which is 25 N/15 mm, indicating that the composite current collector 100 has a strong tensile strength.

After the composite current collector 100 is welded to a tab, the weld mark residual rate on the tab side is 100%, indicating a good welding effect.

The internal resistance of a cell made from the composite current collector 100 (2000 mAh) is 15-15.5 mΩ, while the internal resistance of a cell made from a traditional current collector (2000 mAh) is 13 mΩ, indicating that a cell made from the composite current collector still has a small internal resistance even with a non-conductive substrate, which is only about 15% larger (less than 30%) than that of a cell made from a traditional metal battery cell, and can still have good conductivity.

The weight of a cell made from the composite current collector (5500 mAh) is about 79 g, and the weight of a cell made from a conventional current collector (5500 mAh) is about 98 g. Therefore, a cell made from the composite current collector is lighter than a cell made from a conventional current collector.

Electric performance test: For a ternary cell made from the composite current collector, the capacity retention ratio is 75% in 1700 cycles of discharging, showing no significant decrease, which is approximately equal to the ternary system cycle performance of a cell made from a traditional current collector, and can meet the requirement on electric performance.

In a first aspect, the present disclosure provides a bipolar current collector, including a cathode metal layer, an anode metal layer, and a substrate disposed between the cathode metal layer and the anode metal layer, among which the material of the cathode metal layer includes one or more elements selected from the group consisting of Ni, Ti, Ag, Au, Pt, Co, Cr, W, Mo, Al, Mg, Ba, Ge, Sb, In, and Zn, and the material of the anode metal layer includes one or more elements selected from the group consisting of Ni, Ti, Cu, Ag, Au, Pt, Co, Cr, W, Mo, Mg, Ba, Si, Ge, Sb, In, and Zn.

Specifically, the structure of the bipolar current collector according to the present disclosure is shown in FIG. 6, in which 1 is the cathode metal layer, 2 is the anode metal layer, and 3 is the substrate. In the present disclosure, when the cathode metal layer and the anode metal layer are made of multiple materials, the multiple materials can be distributed in one layer, or arranged in layers by material type. That is, each layer is made of a material, and different layers of material are arranged in a stacked manner.

In a preferred embodiment method, the material of the substrate includes one or more constituents selected from the group consisting of polyethylene terephthalate (PET), o-phenylphenol (OPP) film, biaxially oriented polypropylene (BOPP) film, cast polypropylene, polyimide, polyvinyl chloride composite material, polybutylene terephthalate, polyethylene naphthalate, polyetheretherketone, polyamide, polyethylene glycol, polyamide-imide, polycarbonate, cyclic olefin polymer/copolymer, polyphenylene sulfide (PPS), polyvinyl acetate, polytetrafluoroethylene, polymethylenenaphthalene, polyvinylidene fluoride, polypropylene carbonate, poly(vinylidene fluoride-co-hexafluoropropylene), poly(vinylidene fluoride-co-trifluorochloroethylene), silicone, vinylon, polypropylene, polyethylene, polystyrene, polyethernitrile, polyurethane, polyphenylene ether, polyester, polysulfone and their derivatives.

In a preferred embodiment method, the thickness of the substrate is 1-8 μm. For example, the thickness of the substrate can be 1 μm, 1.5 μm, 2 μm, 2.5 μm, 3 μm, 3.5 μm, 4 μm, 4.5 μm, 5 μm, 5.5 μm, 6 μm, 6.5 μm, 7 μm, 7.5 μm, 8 μm, and any value between any two numerical values.

In a preferred embodiment method, the thickness of the cathode metal layer is 0.2-2 μm. For example, the thickness of the cathode metal layer can be 0.2 μm, 0.3 μm, 0.4 μm, 0.5 μm, 0.6 μm, 0.7 μm, 0.8 μm, 0.9 μm, 1 μm, 1.2 μm, 1.6 μm, 1.8 μm, 2 μm, and any value between any two numerical values.

In a preferred embodiment method, the thickness of the anode metal layer is 0.1-2 μm. For example, the thickness of the anode metal layer can be 0.1 μm, 0.2 μm, 0.3 μm, 0.4 μm, 0.5 μm, 0.6 μm, 0.7 μm, 0.8 μm, 0.9 μm, 1 μm, 1.2 μm, 1.6 μm, 1.8 μm, 2 μm, and any value between any two numerical values.

In a preferred embodiment method, the total thickness of the cathode metal layer and the anode metal layer is 0.3-4 μm. For example, the total thickness of the cathode metal layer and the anode metal layer can be 0.3 μm, 0.5 μm, 0.7 μm, 0.8 μm, 1 μm, 1.5 μm, 1.8 μm, 2 μm, 2.5 μm, 2.8 μm, 3 μm, 3.5 μm, 3.8 μm, 4 μm, and any value between any two numerical values.

In a preferred embodiment method, the bipolar current collector has high volume energy density, high conductivity, good ductility and low surface density.

In a second aspect, the present disclosure provides a method for preparing the bipolar current collector according to the first aspect of the present disclosure, including: depositing a cathode metal layer and an anode metal layer on the two sides of the substrate respectively. Specifically, the depositing is carried out by using one or more methods selected from the group consisting of evaporation, sputtering, chemical vapor deposition, and chemical plating.

Among them, the evaporation, sputtering, chemical vapor deposition and chemical plating in the present disclosure are well-known methods in this field. All evaporation, sputtering, chemical vapor deposition and chemical plating operation methods available in this field can be used in the present disclosure, and the present disclosure does not make any special restrictions. Preferably, the evaporation can be vacuum evaporation or ion plating; the sputtering can be radio frequency sputtering, magnetron sputtering or reactive sputtering; and the chemical vapor deposition can be chemical vapor deposition, plasma vapor deposition, atomic layer deposition or pulsed laser deposition.

In a third aspect, the present disclosure provides a bipolar electrode, including a cathode active substance, an anode active substance, and the bipolar current collector according to the first aspect of the present disclosure, among which the cathode active substance is arranged on the cathode metal layer of the bipolar current collector, and the anode active substance is arranged on the anode metal layer of the bipolar current collector.

Among them, the present disclosure does not make special restrictions on cathode active substances and anode active substances. According to specific working conditions, cathode active substances and anode active substances available in this field can be used in the present disclosure.

In a preferred embodiment method, the cathode active substance includes one or more constituents selected from the group consisting of lithium-containing transition metal oxides and lithium-containing transition metal phosphates or phosphides. Preferably, the lithium-containing transition metal oxide is a ternary cathode material, a nickel-manganese cathode material, or a lithium-rich manganese-based cathode material. Further preferably, the ternary cathode material is high-nickel-content ternary cathode material. Further preferably, the cathode active substance includes one or more constituents selected from lithium cobalt oxide, lithium iron phosphate, and lithium manganese iron phosphate.

In a preferred embodiment method, the anode active substance includes one or more constituents selected from the group consisting of artificial graphite, natural graphite, mesocarbon microbeads, hard carbon, petroleum coke, carbon fiber, pyrolytic carbon from resins, silicon-carbon materials, and silicon-oxygen materials. Among them, silicon carbon materials and silicon oxygen materials in the present disclosure are active substances well-known in the art, and will not be repeated in the present disclosure.

In a preferred embodiment method, the method for preparing the bipolar electrode includes: coating a cathode active substance slurry on the cathode metal layer of the bipolar current collector, coating an anode active substance slurry on the anode metal layer of the bipolar current collector, and then drying, to obtain the bipolar electrode.

In a preferred embodiment method, the cathode active material slurry includes a cathode active substance and a solvent I. Specifically, the solvent I includes one or more constituents selected from the group consisting of water, ketones, and alcohols, and the mass content of the cathode active substance in the cathode active material slurry is in the range from 50% to 70%. Ketones and Alcohols can be conventional solvents in this field, and the present disclosure does not make any special restrictions.

In a preferred embodiment method, the anode active material slurry includes an anode active substance and a solvent II. Specifically, the solvent II includes one or more constituents selected from the group consisting of water, ketones, and alcohols, and the mass content of the anode active substance in the anode active material slurry is in the range from 40% to 60%.

In a preferred embodiment method, the coating is carried out by using one or more methods selected from the group consisting of spraying, press printing, printing, roller coating, and spin coating.

In a fourth aspect, the present disclosure provides a lithium battery including the bipolar electrode according to the third aspect of the present disclosure.

The present disclosure further provides a lithium battery, including the bipolar electrode according to the embodiment methods described above. Preferably, inside the battery, the bipolar electrodes are arranged by stacking or winding. Through the application of the above-described bipolar electrode, compared with existing lithium batteries, the volume of the battery according to the present disclosure is relatively greatly reduced, especially the thickness is smaller, and it has property advantages such as higher effective volume energy density.

The present disclosure is described in detail below by embodiments.

### EXAMPLES OF PREPARING BIPOLAR CURRENT COLLECTOR

### Embodiment 1

(1) Clean and activate the surfaces of a 6 μm thick PET film, and place the cleaned and activated PET film and industrial-grade pure aluminum in a roll-to-roll vacuum evaporation unit for evaporation at the vacuum pressure of 3.5×10⁻³ Pa and the coating rate of 10 cm/min, to form an 1 μm thick cathode metal layer on one side of the PET film; and

(2) after evaporation according to step (1), place the film and industrial-grade pure copper in a roll-to-roll vacuum evaporation unit for evaporation at the vacuum pressure of 3.5×10⁻³ Pa and the coating rate of 10 cm/min, to form an 1 μm thick anode metal layer on the other side of the PET film, to obtain a bipolar current collector.

### Embodiment 2

(1) Clean and activate the surfaces of a 4 μm thick PET film, and place the cleaned and activated PET film and industrial-grade pure aluminum in a roll-to-roll vacuum evaporation unit for evaporation at the vacuum pressure of 3.5×10⁻³ Pa and the coating rate of 10 cm/min, to form a 0.2 μm thick cathode metal layer on one side of the PET film; and

(2) after evaporation according to step (1), place the film and industrial-grade pure nickel in a roll-to-roll vacuum evaporation unit for evaporation at the vacuum pressure of 3.5×10⁻³ Pa and the coating rate of 10 cm/min, to form a 0.1 μm thick anode metal layer on the other side of the PET film, to obtain a bipolar current collector.

### Embodiment 3

(1) Clean and activate the surfaces of an 8 μm thick PET film, and place the cleaned and activated PET film and industrial-grade pure titanium in a roll-to-roll vacuum evaporation unit for evaporation at the vacuum pressure of 3.5×10⁻³ Pa and the coating rate of 10 cm/min, to form a 2 μm thick cathode metal layer on one side of the PET film; and

(2) after evaporation according to step (1), place the film and industrial-grade pure copper in a roll-to-roll vacuum evaporation unit for evaporation at the vacuum pressure of 3.5×10⁻³ Pa and the coating rate of 10 cm/min, to form a 2 μm thick anode metal layer on the other side of the PET film, to obtain a bipolar current collector.

### Embodiment 4

(1) Clean and activate the surfaces of a 4 μm thick PPS film, and place the cleaned and activated PPS film and industrial-grade pure zinc in a roll-to-roll vacuum evaporation unit for evaporation at the vacuum pressure of 3.5×10⁻³ Pa and the coating rate of 10 cm/min, to form an 1 μm thick cathode metal layer on one side of the PPS film; and

(2) after evaporation according to step (1), place the film and industrial-grade pure magnesium in a roll-to-roll vacuum evaporation unit for evaporation at the vacuum pressure of 3.5×10⁻³ Pa and the coating rate of 10 cm/min, to form an 1 μm thick anode metal layer on the other side of the PPS film, to obtain a bipolar current collector.

### Embodiment 5

(1) Clean and activate the surfaces of a 6 μm thick BOPP film, and place the cleaned and activated BOPP film and industrial-grade pure titanium in a roll-to-roll vacuum evaporation unit for evaporation at the vacuum pressure of 3.5×10⁻³ Pa and the coating rate of 10 cm/min, to form an 1 μm thick cathode metal layer on one side of the BOPP film; and

(2) after evaporation according to step (1), place the film and industrial-grade pure nickel in a roll-to-roll vacuum evaporation unit for evaporation at the vacuum pressure of 3.5×10⁻³ Pa and the coating rate of 10 cm/min, to form a 1 μm thick anode metal layer on the other side of the BOPP film, to obtain a bipolar current collector.

### Embodiment 6

The difference from Embodiment 1 is that: industrial-grade pure aluminum is replaced by Al and Mg, and the weight ratio between Al and Mg is 1:1; and industrial-grade pure copper is replaced by Cu, and Zn, and the weight ratio between Cu and Zn is 1:1.

### Embodiment 7

The difference from Embodiment 1 is that: industrial-grade pure aluminum is replaced by Ni and Cr, and the weight ratio between Ni and Cr is 1:1; and industrial-grade pure copper is replaced by Cu and Ni, and the weight ratio between Cu and Ni is 1:1.

### Embodiment 8

The difference from Embodiment 1 is that: industrial-grade pure aluminum is replaced by Ni and Al, and the weight ratio between Ni and Al is 1:1; and industrial-grade pure copper is replaced by Ti and Mo, and the weight ratio between Ti and Mo is 1:1.

### Embodiment 9

The difference from Embodiment 1 is that: industrial-grade pure aluminum is replaced by Ni and Ti, and the weight ratio between Ni and Ti is 1:1; and industrial-grade pure copper is replaced by Ni and Cr, and the weight ratio between Ni and Cr is 1:1.

### Embodiment 10

The difference from Embodiment 1 is that: industrial-grade pure aluminum is replaced by Mo and Ti, and the weight ratio between Mo and Ti is 1:1; and industrial-grade pure copper is replaced by Ni and Cr, and the weight ratio between Ni and Cr is 1:1.

### Embodiment 11

The difference from Embodiment 1 is that: industrial-grade pure aluminum is replaced by Al, Zn and Mg, and the weight ratio among Al, Zn, and Mg is 1:1:1; and industrial-grade pure copper is replaced by Ni and Cr, and the weight ratio between Ni and Cr is 1:1.

### Comparative Example 1

The steps of preparing the bipolar current collector are the same as those in Embodiment 1, except that the obtained cathode metal layer is 3 μm thick, and the anode metal layer is 3 μm thick.

### Test Example 1

Test the bipolar current collectors obtained according to embodiments and the comparative example of this application described above for ductility, surface density and sheet resistance. The test results are shown in Table 1:

Longitudinal ductility: Refer to GBT 1040.3-2006 Plastics-Determination of Tensile Properties—Part 3: Test Conditions for Films and Sheets.

Surface density: Refer to GB/T 22638. 10-2016 Test Methods for Aluminium and Aluminium Alloy Foils—Part 10: Determination of Mass per Unit Area (Surface Density) of Coatings.

Sheet resistance: Refer to ASTM F390 Standard Test Method for Sheet Resistance of Thin Metallic Films With a Collinear Four-Probe Array.

TABLE 1

| | | | Sheet Resistance | |
|---|---|---|---|---|
| | Longitudinal | | (mΩ/sq) | |
| | Ductility | Surface Density | Cathode | Anode |
| | (%) | (g/m²) | Side | Side |
| Embodiment 1 | 73.5 | 19.88 | 31.7 | 25.6 |
| Embodiment 2 | 83.2 | 7.828 | 17.5 | 684.2 |
| Embodiment 3 | 67.9 | 37.18 | 216.5 | 13.5 |
| Embodiment 4 | 62.7 | 20.18 | 53.4 | 112.1 |
| Embodiment 5 | 37.6 | 18.87 | 422.0 | 74.5 |
| Embodiment 6 | 73.6 | 18.95 | 35.7 | 28.2 |
| Embodiment 7 | 72.4 | 25.68 | 80.4 | 30.5 |
| Embodiment 8 | 74.1 | 19.95 | 36.9 | 85.4 |
| Embodiment 9 | 72.7 | 20.12 | 109.4 | 103.5 |
| Embodiment 10 | 71.9 | 21.66 | 102.5 | 103.7 |
| Embodiment 11 | 73.3 | 19.32 | 34.2 | 104.1 |
| Comparative | 63.6 | 43.06 | 10.7 | 6.2 |
| Example 1 | | | | |

### Examples of Preparing Bipolar Electrode

Prepare the bipolar current collectors obtained according to embodiments and the comparative example described above into electrodes. Taking the bipolar current collector obtained according to Embodiment 1 as an example, the specific method is as follows:

Place the bipolar current collector obtained according to Embodiment 1 on a coating machine, coat the cathode material slurry on the cathode metal layer at the coating rate of 16 m/min and the tension of 15N, dry at 100° C., coat the anode material slurry on the anode metal layer, dry at 100° C. again, and then cut, to obtain a bipolar electrode.

In this process, the solvent of the cathode material slurry is NMP, containing 96 wt % LiCoO₂, 2 wt % SP, 0.5 wt % CNTs, and 1.5 wt % PVDF; and the solvent of the anode material slurry is deionized water, containing 94.9 wt % artificial graphite, 1.5 wt % SP, 0.5 wt % CNTs, 1.8 wt % SBR, and 1.3 wt % CMC.

### Test Example 2

Assemble the bipolar electrodes obtained according to embodiments into batteries, and then test the batteries for electrochemical properties. The test results are shown in Table 2.

In the test of a battery, the ACR is tested as follows: Take a Hioki BT3562A internal resistance tester, clamp its test fixtures on the cathode and anode tabs of the battery respectively, and measure the internal resistance of the battery.

The K value is tested as follows: After the battery is prepared, take a voltage internal resistance meter, measure the voltage V1 of the battery at 70% to 80% SOC, let it stand at a constant temperature of 25° C. for 24 h, and measure the voltage V2 again. Then, K value=(V1−V2)/24.

The capacity retention ratio is tested as follows: At room temperature, charge the battery at the current of 1 C, switch to constant voltage charging at the charging termination voltage, stop charging when the charging current drops to 0.05 C, and let it stand for 30 minutes; discharge the battery at the current of 1 C to the discharging termination voltage, and let it stand for 30 minutes; repeat the charging and recharging cycle; stop the test when the capacity retention ratio reaches 80%. Discharge capacity retention ratio=(Current discharge capacity/Initial discharge capacity)×100%.

The volume energy density is tested as follows: At room temperature, charge the battery at the current of 0.5 C, switch to constant voltage charging at the charging termination voltage, stop charging when the charging current drops to 0.05 C, and let it stand for 10 minutes; discharge the battery at the current of 0.5 C to the discharging termination voltage. Record the discharge energy. Volume energy density=(Discharge capacity/Cell volume)×100%.

TABLE 2

| | | | Number of | |
|---|---|---|---|---|
| | | | Cycles | |
| | | | Required | |
| | | | to | |
| | | | Reach 80% | Volume |
| | | K | Capacity | Energy |
| | ACR | Value | Retention | Density |
| | (mΩ) | (mV/h) | Ratio | (Wh/L) |
| Embodiment 1 | 28.3 | 0.131 | 1150 | 542.2 |
| Embodiment 2 | 33.1 | 0.139 | 803 | 543.1 |
| Embodiment 3 | 30.1 | 0.137 | 877 | 541.3 |
| Embodiment 4 | 29.4 | 0.136 | 880 | 538.4 |
| Embodiment 5 | 31.3 | 0.142 | 835 | 533.7 |
| Embodiment 6 | 27.4 | 0.136 | 1169 | 526.9 |
| Embodiment 7 | 29.1 | 0.139 | 872 | 535.7 |
| Embodiment 8 | 28.9 | 0.141 | 885 | 540.1 |
| Embodiment 9 | 29.5 | 0.136 | 846 | 539.1 |
| Embodiment 10 | 30.3 | 0.143 | 830 | 532.6 |
| Embodiment 11 | 29.8 | 0.142 | 856 | 537.3 |
| Comparative | 27.4 | 0.136 | 1169 | 526.9 |
| Example 1 | | | | |

According to Tables 1 and 2, the thinner the substrate is, the smaller the sheet resistance will be, but the corresponding volume energy density will be also lower. The volume energy density is too low, which is a pain point in the entire technical field, and is also the focus of pursuit and development efforts of the entire technical field. As described in the background part of the present disclosure, it is exactly the technical problem that the present disclosure wants to solve.

According to Table 2, volume energy densities of batteries prepared by using bipolar current collectors according to the present disclosure are above 530 Wh/L. The volume energy density of the battery prepared by using the bipolar current collector according to Comparative Example 1 is 526.9 Wh/L, and the volume energy density of the battery prepared by using the bipolar current collector according to Embodiment 1 can be as high as 542.2 Wh/L, which means that, the volume energy density of the battery prepared by using the bipolar current collector according to Embodiment 1 is 15.3 Wh/L, or about 3%, higher than that of the battery prepared by using the bipolar current collector according to Comparative Example 1. In the field of batteries, every 1% increase in volume energy density is a huge improvement, and the probability of improvement brought up by Embodiment 1 is as high as 3%.

It should be noted that the terms “first”, “second” and so on in the specification and claims of this application are configured to distinguish similar objects, but not necessarily configured to describe a specific sequence or precedence. It should be understood that the terms thus used may be interchangeable under appropriate circumstances so that embodiments of the present application described herein can be implemented in sequences other than those described herein.

The above descriptions are only preferred embodiments of the present disclosure and not intended to limit the present disclosure. For those skilled in the art, the present disclosure can have various changes and variations. Any modification, equivalent substitution and improvement made within the spirit and principle of the present disclosure shall be covered by the protection scope of the present disclosure.

What is claimed is:

1. A composite current collector for lithium batteries, comprising:
a substrate layer;
a first metal material layer, which is arranged on one side of the substrate layer, and is to be coated with a first active material on the side away from the substrate layer; and
a second metal material layer, which is arranged on the side of the substrate layer away from the first metal material layer, and is to be coated with a second active material on the side away from the substrate layer, with the polarity of the second active material being opposite to the polarity of the first active material.

2. The composite current collector according to claim 1, wherein the first metal material layer comprises:
a first metal material sublayer, which is arranged on the side of the substrate layer; and
a second metal material sublayer, which is arranged on the side of the first metal material sublayer away from the substrate layer, and is to be coated with the first active material on the side away from the first metal material sublayer.

3. The composite current collector according to claim 2, wherein the orthographic projection of the first metal material sublayer on the substrate layer coincides with the orthographic projection of the second metal material sublayer on the substrate layer.

4. The composite current collector according to claim 1, wherein the material of the substrate layer comprises one or more constituents selected from the group consisting of polyethylene terephthalate, o-phenylphenol, cast polypropylene, polyimide, polyvinyl chloride, polybutylene terephthalate, polyethylene naphthalate, polyetheretherketone, polyamide, polyethylene glycol, polyamide-imide, polycarbonate, cyclic olefin polymer/copolymer, polyphenylene sulfide, polyvinyl acetate, polytetrafluoroethylene, polymethylenenaphthalene, polyvinylidene fluoride, polypropylene carbonate, poly(vinylidene fluoride-co-hexafluoropropylene), poly(vinylidene fluoride-co-chlorotrifluoroethylene), silicone, vinylon, polypropylene, polyethylene, polystyrene, polyethernitrile, polyurethane, polyphenylene ether, polyester, polysulfone, and their derivatives; or, the material of the substrate layer comprises one or more constituents selected from the group consisting of polyethylene terephthalate, o-phenylphenol, biaxially oriented polypropylene film, cast polypropylene, polyimide, polyvinyl chloride, polybutylene terephthalate, polyethylene naphthalate, polyetheretherketone, polyamide, polyethylene glycol, polyamide-imide, polycarbonate, cyclic olefin polymer/copolymer, polyphenylene sulfide, polyvinyl acetate, polytetrafluoroethylene, polymethylenenaphthalene, polyvinylidene fluoride, polypropylene carbonate, poly(vinylidene fluoride-co-hexafluoropropylene), poly(vinylidene fluoride-co-chlorotrifluoroethylene), silicone, vinylon, polyurethane, polyethylene, olystyrene, polyethernitrile, polyurethane, polyphenylene ether, polyester, polysulfone, and their derivatives;
the thickness of the substrate layer is 1-8 μm, and preferably 4-8 μm;
optionally, the material of any one of the first metal material layer and the second metal material layer comprises one or more elements selected from the group consisting of Ni, Ti, Cu, Ag, Au, Pt, Fe, Co, Cr, W, Mo, Al, Mg, K, Na, Ca, Sr, Ba, Si, Ge, Sb, Pb, In, and Zn;
optionally, the material of the first metal material sublayer comprises Al, and the material of the second metal material sublayer comprises Cu;
optionally, the thickness of the first metal material sublayer is 0.2-2 μm, and the thickness of the second metal material sublayer is 0.1-2 μm;
optionally, the material of the second metal material layer comprises Al, and the thickness of the second metal material layer is 0.3-4 μm;
optionally, at least one of the first metal material sublayer and the second metal material sublayer is formed by using one or more methods selected from the group consisting of evaporation, deposition, and sputtering;
optionally, the second metal material layer is formed by using one or more methods selected from the group consisting of evaporation, deposition, and sputtering; and
optionally, the first active material comprises an anode active material, and the second active material comprises a cathode active material.

5. The composite current collector according to claim 4, wherein the first metal material layer is a cathode metal layer, and the second metal material layer is an anode metal layer, wherein the material of the cathode metal layer comprises one or more elements selected from the group consisting of Ni, Ti, Ag, Au, Pt, Co, Cr, W, Mo, Al, Mg, Ba, Ge, Sb, In, and Zn, and the material of the anode metal layer includes one or more elements selected from the group consisting of Ni, Ti, Cu, Ag, Au, Pt, Co, Cr, W, Mo, Mg, Ba, Si, Ge, Sb, In, and Zn.

6. The composite current collector according to claim 1, wherein the first metal material layer is a cathode metal layer, and the second metal material layer is an anode metal layer;
preferably, the thickness of the cathode metal layer is 0.2-2 μm;
preferably, the thickness of the anode metal layer is 0.1-2 μm; and
preferably, the total thickness of the cathode metal layer and the anode metal layer is 0.3-4 μm.

7. A composite electrode sheet, comprising:
the composite current collector according to claim 1;
a first active material layer, which is arranged on the side of the first metal material layer away from the substrate layer; and
a second active material layer, which is arranged on the side of the second metal material layer away from the substrate layer.

8. The composite electrode sheet according to claim 7, comprising a cathode active substance, an anode active substance, and the composite current collector, wherein the first metal material layer is a cathode metal layer, and the second metal material layer is an anode metal layer, wherein the cathode active substance is arranged on the cathode metal layer, and the anode active substance is arranged on the anode metal layer.

9. The composite electrode sheet according to claim 7, wherein the first active material is a cathode active substance, which comprises a lithium-containing transition metal oxide, or comprises one or more constituents selected from the group consisting of lithium-containing transition metal oxides and lithium-containing transition metal phosphates or phosphides;
preferably, the lithium-containing transition metal oxide is a ternary cathode material, a nickel-manganese cathode material, or a lithium-rich manganese-based cathode material;
preferably, the ternary cathode material is a high-nickel-content ternary cathode material; and
more preferably, the cathode active substance comprises one or more constituents selected from the group consisting of lithium cobalt oxide, lithium iron phosphate, and lithium manganese iron phosphate; or comprises LiCoO₂ and/or LiFePO₄.

10. The composite electrode sheet according to claim 7, wherein the second active material is an anode active substance and the anode active substance comprises one or more constituents selected from the group consisting of artificial graphite, natural graphite, mesocarbon microbeads, petroleum coke, carbon fiber, pyrolytic carbon from resins, silicon-carbon materials, and silicon-oxygen materials; or
the anode active substance comprises one or more constituents selected from the group consisting of artificial graphite, natural graphite, mesocarbon microbeads, hard carbon, petroleum coke, carbon fiber, pyrolytic carbon from resins, silicon-carbon materials, and silicon-oxygen materials.

11. The composite electrode sheet according to claim 8, wherein the method for preparing the composite electrode sheet comprises the following steps: coating a cathode active material slurry on the cathode metal layer of the composite current collector, coating an anode active material slurry on the anode metal layer of the composite current collector, and then drying, to obtain the composite electrode sheet.

12. The composite electrode sheet according to claim 8, wherein the cathode active material slurry comprises a cathode active substance and a solvent I, wherein the solvent I comprises one or more constituents selected from the group consisting of water, ketones, and alcohols, and the mass content of the cathode active substance in the cathode active material slurry is in the range from 50% to 70%; and
preferably, the anode active material slurry comprises an anode active substance and a solvent II, wherein the solvent II comprises one or more constituents selected from the group consisting of water, ketones, and alcohols, and the mass content of the anode active substance in the anode active material slurry is in the range from 40% to 60%.

13. A lithium battery, comprising the composite electrode sheet according to claim 7.

14. A method for manufacturing the composite current collector, comprising:
providing a substrate layer;
forming a first metal material layer on the substrate layer, wherein the first metal material layer is to be coated with a first active material on the side away from the substrate layer; and
forming a second metal material layer on the side of the substrate layer away from the first metal material layer, wherein the second metal material layer is to be coated with a second active material on the side away from the substrate layer, with the polarity of the second active material being opposite to that of the first active material.

15. The manufacturing method according to claim 14, wherein the forming a first metal material layer on the substrate layer comprises:
forming a first metal material sublayer on one side of the substrate layer; and
forming a second metal material sublayer on the side of the first metal material sublayer away from the substrate layer, wherein the second metal material sublayer is to be coated with the first active material on the side away from the first metal material sublayer;
optionally, the orthographic projection of the first metal material sublayer on the substrate layer coincides with the orthographic projection of the second metal material sublayer on the substrate layer;
optionally, the forming a first metal material sublayer on one side of the substrate layer comprises:
forming an Al-made first metal material sublayer on one side of the substrate layer by using one or more methods selected from the group consisting of evaporation, deposition, and sputtering; and
optionally, the forming a second metal material sublayer on the side of the first metal material sublayer away from the substrate layer comprises:
forming a Cu-made second metal material sublayer on the side of the first metal material sublayer away from the substrate layer by using one or more methods selected from the group consisting of evaporation, deposition, and sputtering.

16. The manufacturing method according to claim 14, wherein the forming a second metal material layer on the side of the substrate layer away from the first metal material layer comprises:
forming an Al-made second metal material layer on the side of the substrate layer away from the first metal material layer by using one or more methods selected from the group consisting of evaporation, deposition, and sputtering.

17. The manufacturing method according to claim 14, wherein the first metal material layer is a cathode metal layer, the second metal material layer is an anode metal layer, and the method comprises: depositing the cathode metal layer and the anode metal layer on the two surfaces of the substrate respectively; wherein the depositing is carried out by using one or more methods selected from the group consisting of evaporation, sputtering, chemical vapor deposition, and chemical plating.

18. A method for manufacturing the composite electrode sheet, comprising:
the method for manufacturing the composite current collector according to claims 14;
coating the first active material on the side of the first metal material layer away from the substrate layer; and
coating the second active material on the side of the second metal material layer away from the substrate layer.
